(19) United States
(12) Patent Application Publication
(10) Pub. No.: US 2001/0026825 A1
(43) Pub. Date: Oct. 4, 2001

(54) Ultra-high temperature milk concentrate package and method of producing same

(76) Inventors: Ronald A. Reaves, Cincinnati, OH (US); Ronnie L. Howard, Dayton, OH (US); Gary F. Senyk, Binghamton, NY (US)

Correspondence Address: Neil F. Markva, Springfield Professional Park, 8322A Traford Lane, Springfield, VA, 22152, US

(21) Appl. No.: 09/850,983

(22) Filed: May 8, 2001

Related U.S. Application Data
(63) Continuation of application No. 09/433,365, filed on Nov. 3, 1999.

(51) Int. Cl. A23C 3/02

(52) U.S. Cl. 426/511; 426/522; 426/399; 426/130; 426/580; 426/576

(57) ABSTRACT

An ultrapasteurized liquid milk concentrate to provide a reconstituted milk beverage that tastes like fresh milk and a method for producing same. The method comprises heating a milk starting product to an elevated pasteurizing temperature under reduced pressure for an amount of time sufficient to evaporate liquid from the milk starting product to form a pasteurized, high-solids intermediate liquid milk concentrate. An amount of cream is mixed with the intermediate milk concentrate to form a condensed liquid blend having a preselected amount of fat content to produce said reconstituted milk beverage having the desired taste characteristics. A sufficient amount of a stabilizer material with a predetermined amount of said condensed liquid blend to produce a final liquid milk concentrate. The stabilizer material is effective to ensure uniform distribution of and prohibit separation and settling of milk solids in the ultrapasteurized liquid milk concentrate during storage. The final liquid milk concentrate is ultrapasteurized, homogenized and packaged to form an ultrapasteurized liquid milk concentrate package for subsequent mixing of the ultrapasteurized milk concentrate with water to form said reconstituted milk beverage.

Pursuant to 37 CFR 1.53(b), this is a continuation of U.S. application Ser. No. 09/433,365 filed Nov. 3, 1999.

### FIELD OF THE INVENTION

This invention relates to producing and packaging ultra-high temperature (UHT) pasteurization of condensed milk for dispensing reconstituted milk from currently available juice dispensing equipment and for transporting large amounts of ultrapasteurized (UP) liquid milk concentrate worldwide.

### BACKGROUND OF THE INVENTION

The cost of transporting and storing fresh milk is significant because of its short shelf life and weight. And because fresh milk is used extensively by America's military and is one of its largest export commodities, there is a long-felt need for a milk concentrate that has a longer shelf life and a product package with a lesser weight for transportation and storage and when reconstituted provides the same physical and taste characteristics of fresh milk.

The prior art addresses various aspects of the UHT pasteurization of milk, the production of condensed milk products, and the reconstituting of concentrated liquid beverages. No known prior art, however, discloses an ultrapasteurized liquid milk concentrate packaged for dispensing a reconstituted milk beverage in existing beverage dispensers or for transporting large amounts of UHT pasteurized milk concentrate worldwide to provide a reconstituted milk at the destination that has the same physical characteristics of and tastes like fresh milk.

U.S. Pat. No. 2,860,057 discloses a known preparation of a sterilized evaporated or condensed milk having a final desired concentration of from about 1.6% to 35% total solids compared to the standard concentration of about 8.0-8.5% total solids. The different processes each involve forewarming and pasteurizing steps including high-temperature-short-term sterilization after the milk is first concentrated by conventional means. The disclosed processing avoids age thickening or gelation of the milk during high-temperature sterilization effected either before or after packaging in a can. If an aseptic canning method is used, the sterilized concentrate is subsequently homogenized under sterile conditions. Reconstitution involves a complicated dilution, mixing, and color comparison procedure with disclosed mixing volume ratio of water to evaporated milk of 1:1.

U.S. Pat. No. 4,921,717 describes a process for producing UHT sterilized concentrated milk including first sterilizing a partially concentrated milk product and then effecting further concentration of the milk product under sterile conditions. The processing teaches away from using stabilizers in the disclosed milk concentrate made from whole or skimmed cow's milk. Although the concentrated milk may be diluted for use in place of fresh milk, applicants' efforts to produce a reconstituted milk beverage that tastes like fresh milk from UHT sterilized concentrated milk having no stabilizers have proven fruitless. And this is particularly true when using beverage dispensers to effect the reconstituting process. The patent generally describes diluting sterilized concentrated milk for use in place of fresh milk but discloses no particulars how that is allegedly done.

U.S. Pat. No. 4,842,884 describes a formulated milk concentrate made with a mixture of nonfat dry milk solids, water, edible oil and sugar. The concentrate can either be frozen for later use or immediately blended with water to produce a beverage. Once reconstituted, it may be stored for up to about 5 days. Nothing disclosed in this patent enables anyone to form a milk concentrate that may be stored in its liquid state at least 60 days and for more than 90 days and be reconstituted using known juice dispensing equipment.

U.S. Pat. Nos. 2,570,231; 3,108,875; 4,362,756; and 5,766,666 respectively disclose a sweetened condensed skim milk, condensed cream, condensed milk having at least 8% milk fat, and a reduced fat and/or fat-free condensed milk each processed differently to produce a novel sweetened condensed dairy product in each instance. The condensed cream is used for a source of fat in ice cream. And the other three condensed milk products are used in the baking and confectionery industries and by retail consumers to produce baked goods. U.S. Pat. No. 4,091,118 describes a vegetable-based sweetened condensed milk used as a coffee creamer. None of these patents, however, discloses a condensed liquid milk product for providing a reconstituted beverage that tastes like fresh milk.

U.S. Pat. No. 2,565,085 discloses the customary forewarming of whole milk to destroy bacteria, molds, yeasts, and the like. The forewarming also helps to maintain the texture of the milk product. Such forewarming of the milk is usually effected at a temperature in the range of 145° F. to 175° F. Yet this patent replaces the forewarming practice with an ultra-high temperature treatment of the milk before evaporation to produce a milk concentrate, which is not intended for producing a reconstituted beverage from a beverage dispenser or for a package containing up to 300 gallons of ultrapasteurized milk concentrate.

U.S. Pat. No. 5,260,079 describes a method of and equipment for controlling the content of fat in milk using specified process parameters for mixing skim milk with cream. And U.S. Pat. Nos. 5,223,299 and 5,229,159 disclose sterilizing milk without stabilizers and a packaged resultant milk concentrate product for use as coffee creamers.

Finally, U.S. Pat. No. 4,282,262 discloses a milk blend fraction used as an ingredient component for a two-packet frozen dessert. The milk blend includes sodium hexametaphosphate and carrageenan used together as stabilizers. Nothing in this patent, however, relates to the production of UHT sterilized condensed milk packaged for use with a beverage dispenser in which the milk concentrate may be reconstituted as a milk beverage that has the characteristics of fresh milk. The known stabilizing materials therefore are not related to the functions required in producing the UHT pasteurized milk concentrate of this invention.

Purpose of the Invention

A primary purpose of this invention is to provide a package of an ultrapasteurized concentrated milk product that weighs 3 to 4 times less than the amount of reconstituted milk that is produced therefrom, tastes like regular fresh milk, and has a shelf life of at least 60 and more than 90 days.

Another object of the invention is to provide a packaged concentrated milk product for use in currently available dispensing machines used for reconstituting and dispensing juices.

A further object is to provide a concentrated liquid milk product package that produces substantial cost savings for export, military uses such as for naval ships and submarines, and for commercial and government food service programs.

Still another object of the invention is to provide milk concentrate packages in standard retail pint and quart packages for the general population that yield 1/2 gallon for the pint and one gallon for the quart when reconstituted.

A still further object of the invention is to provide a milk concentrate that is enriched with vitamins and other nutritive ingredients that addresses special dietetic needs of special groups with dietary restrictions.

Another object is to provide an UHT pasteurized liquid milk concentrate packaged in an amount of up to 300 gallons while gaining shelf-life and economic benefits heretofore unknown in the dairy industry and enabling the on-site destination reconstituting of the concentrate using existing dispensing equipment and otherwise using uncomplicated, simple water to milk concentrate mixing techniques in water to concentrate volume ratios in the range of 3:1 to 4:1.

### SUMMARY OF THE INVENTION

The ultrapasteurized milk concentrate package of the invention includes up to 300 gallons of ultrapasteurized liquid milk concentrate. In one embodiment, the package comprises container means including a preselected amount of the ultrapasteurized liquid milk concentrate and has a structural configuration effective for use with dispensing means which includes means for mixing the ultrapasteurized milk concentrate with water to create a reconstituted milk beverage that tastes like fresh milk. The ultrapasteurized milk concentrate includes a high-solids condensed skim milk (HSCS) in the range of 80% to 90% by weight, a cream content in the range of from 8.5% to 10.5% by weight, and a stabilizer content of less than 1%. The initially pasteurized condensed skim milk has a total milk solids nonfat (MSNF) content in the range of 35.0% to 36.5% by weight, said cream has a milk fat content of from 36.0% to 42.0% and said stabilizer content consists essentially of the stabilizing materials sodium hexametaphosphate in the range of 97.0% to 99.0% and carrageenan (kappa type) in the range of 1.0% to 3.0%. In a specific embodiment, the milk concentrate package has a structural configuration effective for disposition of a liquid dispensing means including discharge nozzle means for mixing said ultrapasteurized concentrate with water to dispense the reconstituted liquid milk beverage.

The method for producing the ultrapasteurized liquid milk concentrate of the invention comprises heating a milk starting product to an elevated pasteurizing temperature under reduced pressure for an amount of time to sufficient to evaporate liquid from the milk starting product to form a pasteurized, high-solids intermediate liquid milk concentrate. An amount of cream is mixed with the intermediate milk concentrate to form a condensed liquid blend having a preselected amount of fat content to produce the reconstituted milk beverage having the desired taste characteristics.

A final liquid milk concentrate is produced by mixing a sufficient amount of a stabilizer material with a predetermined amount of the condensed liquid blend. The stabilizer material is effective to ensure uniform distribution of and prohibit separation and settling of milk solids in the ultrapasteurized liquid milk concentrate during storage. The stabilizer material is effective to produce a protein complex for forming a stable dispersion of colloidal constituents and to substantially uniformly distribute the colloidal constituents in the final liquid milk concentrate. The stabilizer materials maintain the preselected pH of the final liquid milk concentrate in the range of 6 to 8 during the ultrapasteurizing step. The stabilizer material is further effective for inhibiting thermal coagulation of milk proteins at the preselected pH of the final milk concentrate. The total MSNF content in the final liquid milk concentrate is at least 29.9% by weight of the concentrate to produce a reconstituted milk beverage having a MSNF content of at least 8.25%.

The final liquid milk concentrate is ultrapasteurized to form the ultrapasteurized liquid milk concentrate of the invention. The final homogenizing and packaging of the ultrapasteurized milk concentrate forms the ultrapasteurized liquid milk concentrate package of the invention for subsequent mixing of the ultrapasteurized milk with water to form the reconstituted desired reconstituted milk beverage.

A feature of the invention is directed to a heating step that includes foreheating the initial liquid milk to an elevated foreheating temperature for a selected time period to produce the milk starting product, which is then heated to the elevated pasteurizing temperature that is higher than the foreheating temperature to produce the desired intermediate liquid milk concentrate. When the initial liquid milk is a skim milk, the elevated foreheating temperature is in a range of about 144° F. to about 152° F. and the elevated pasteurizing temperature is maintained in the range of 178° F. to 182° F. for a time period in the range from 16-22 seconds to pasteurize the intermediate liquid milk concentrate.

Another feature is directed to the manner of preparing the stabilizer material for mixing with the condensed liquid blend. In a specific embodiment, the stabilizer material is first solubilized in water under high shear conditions and at an elevated temperature to form a stabilizer slurry that is mixed with the condensed liquid blend to form the final liquid milk concentrate. The stabilizer slurry includes sodium hexametaphosphate and carrageenan so that when the slurry is mixed with the condensed liquid blend, the carrageenan forms a protein carrageenate complex with milk protein to provide the stable dispersion of colloidal constituents. The sodium hexametaphosphate is effective to aid in substantially uniformly distributing the colloidal constituents and inhibiting thermal coagulation in the concentrate. The stabilizer slurry includes a stabilizer material content in the range of 14.7% to 12.5% by weight of the stabilizer slurry to produce a stabilizer material content of less than 1.0% by weight of the final liquid milk concentrate. The stabilizer material includes sodium hexametaphosphate in the range of 14.6% to 20.8% of the stabilizer slurry and carrageenan (kappa type) in the range of 0.15% to 0.7% of the stabilizer slurry.

Another feature of the invention is directed to the particular viscosity of the concentrates at different times during the processing. The viscosity of the final liquid milk concentrate is in the range of 300 to 400 centipoises at 40° to 45° F. and the viscosity of the ultrapasteurized milk concentrate is in the range of 1,000 to 1,500 centipoises at the same temperature range. The pasteurized intermediate liquid milk concentrate includes a milk solids nonfat content in the range of from 35.0% to 36.5% by weight. The pasteurized intermediate liquid milk concentrate thus includes a MSNF content in an amount of at least 35% to produce a reconstituted low fat milk product upon mixing the ultrapasteurized milk concentrate with water. Moreover, the milk solids nonfat content is no more than 36.5% to preclude burn damage of the final liquid milk concentrate during the ultrapasteurizing step. Water is mixed with the ultrapasteurized milk concentrate to form the reconstituted milk product in a water/concentrate volume ratio of parts of water to parts of ultrapasteurized milk concentrate in the range of about 3:1 to about 4:1.

Another feature of the invention is directed to the composition of the final liquid milk concentrate that includes intermediate high-solids milk concentrate in the range of from about 87% to about 90%, cream in the range of from about 8.5% to about 10.5%, water in the range from about 2.0% to 3.0%, and stabilizer material in the amount of less than 1.0% by weight of the concentrate. The reconstituted milk beverage includes a milk fat content in the range of less than 0.21% to 3.25% and a milk solids nonfat content of at least 8.25% by weight of the milk beverage.

A further feature of the invention is directed to the ultrapasteurizing step that includes heating the final liquid milk concentrate to an elevated ultrapasteurizing temperature for a period of time sufficient to form the ultrapasteurized liquid milk concentrate. A specific embodiment, the ultrapasteurizing step includes heating the final liquid milk concentrate to a temperature in the range of 288° F. to 292° F. for a period of time sufficient to produce a ultrapasteurized liquid milk concentrate of the invention. More specifically, the ultrapasteurizing heating step includes first heating the final liquid milk concentrate to a first elevated temperature of about 180° F. for a period from 30 to 36 seconds and then directing the heated final liquid milk concentrate to a direct steam infusion zone to be heated to 290° F. for a period of four seconds.

The homogenizing step comprises homogenizing the ultrapasteurized milk concentrate in the range of 2,400 to 2,600 PSI in a first stage of about 2,000 PSI and a second stage of about 500 PSI. The packaging step feature after homogenizing includes the step of cooling the ultrapasteurized milk concentrate to a temperature of less than 40° F. and filling packaging means with the ultrapasteurized milk concentrate for disposition in a liquid beverage dispenser. In this packaging step, the ultrapasteurized milk concentrate is disposed in a package for use in a beverage dispenser that includes discharge nozzle means for mixing the ultrapasteurized milk concentrate with water to form the desired reconstituted milk beverage. In a further specific embodiment, the packaging step includes disposing up to 300 gallons of the ultrapasteurized milk concentrate in a package container.

In another embodiment of the invention, a preselected amount of liquid skim milk to a temperature in the range of 144° to 152° F. for an amount of time sufficient to produce a preheated milk starting product. The preheated milk starting product is then pasteurized in the range of 178° F. to 182° F. in a time period in the range of 16-22 seconds. The pasteurizing step is effected under a vacuum to evaporate liquid from the milk starting product to produce an intermediate condensed liquid milk including milk solids nonfat in the range of 35.0% to 36.5% by weight. Cream and stabilizing material are mixed with the intermediate condensed liquid milk to produce a final liquid milk concentrate including a cream content in the range of 8.5% to 10.5% by weight thereof and a stabilizing material content of less than 1.0% thereof. The final liquid milk concentrate is then ultrapasteurized and homogenized to form the ultrapasteurized milk concentrate, which is then disposed in the package container for subsequent reconstitution with water at a water/milk concentrate volume ratio in the range from 3:1 to 4:1.

In another feature of the method of the invention, a liquid milk starting product is heated under vacuum to an elevated temperature for an amount of time sufficient to pasteurize the milk starting product and evaporate liquid from the milk starting product to form a pasteurized, high-solids condensed liquid skim milk including milk nonfat solids in the range of 35.0% to 36.5%. An amount of cream is mixed with the pasteurized condensed skim milk to form a condensed liquid blend having an amount of fat content sufficient for the ultrapasteurized liquid milk concentrate to be reconstituted to qualify as a low fat milk concentrate. An effective amount of a stabilizer slurry is then mixed with a predetermined amount of condensed liquid blend to form a final skim milk concentrate. The stabilizer slurry contains sodium hexametaphosphate and carrageenan (kappa type) in amounts sufficient to prohibit separation, settling, and crystallization of milk constituents in the final liquid milk concentrate during storage. The final liquid skim milk concentrate is ultrapasteurized, homogenized and packaged to form an ultrapasteurized milk concentrate package for disposing in a liquid dispensing means including discharge nozzle means for mixing the ultrapasteurized milk concentrate with water to dispense a reconstituted low fat milk beverage.

### DETAILED DESCRIPTION OF THE INVENTION

The ultrapasteurized concentrated milk product of the invention is produced using a series of known process steps with novel controlled conditions to achieve new and unexpected results. The heating and cooling steps of the process of the invention may be effected using conventional apparatus as used in the food and dairy industries. For example, one type of such apparatus used for ultrapasteurization is the direct heating plant in which high pressure potable steam is mixed with the liquid milk product either by injecting the steam into the liquid milk product or vice versa. The water added to the liquid milk product is then removed by evaporation, usually under reduced pressure, which also cools the product. The direct steam infusion apparatus effects a continuous ultrapasteurization process known in the dairy industry.

Indirect heating plants rely on heat exchangers usually in plate or tubular form in which the liquid milk product is heated by contact with one surface of the heat exchangers, the other surface of which is heated by steam or pressurized hot water. Cooling is effected in similar heat exchangers. Some heat may be conserved by recycling the heating/cooling liquid between the heating and cooling steps as appropriate. Indirect plants usually heat the liquid milk product in two or more steps and have a similar number of cooling steps.

In a specific embodiment of the invention, the ultrapasteurized milk concentrate is produced in a series of process steps. First, a high solids condensed skim milk (HSCS) is prepared by pasteurizing under vacuum conditions. HSCS and cream are mixed to form 1,000 gallons in a batch tank of a condensed liquid blend having a preselected fat content. A special stabilizer mixture is mixed with warm water under high shear mixing conditions to form a unique stabilizer slurry which is added to the condensed liquid blend to ensure production of a final liquid milk concentrate that will provide a reconstituted milk beverage having the desired taste and milk characteristics. Vitamin A Palmitate and Vitamin D3 are added to the batch, which is then ultrapasteurized and homogenized. The resultant ultrapasteurized milk concentrate is then held in sterile tanks until packaging in an aseptic filler. The milk concentrate of the invention has a refrigerated shelf-life of at least sixty days. The HSCS milk and cream are sources of milk-derived carbohydrates, proteins, and minerals. In addition, the cream brings the desired milk fat content to the UHT pasteurized milk concentrate of the invention.

The process parameters are controlled to maintain the milk solids nonfat content in the HSCS within a critical range and the novel stabilizer system an ultrapasteurization conditions produce an ultrapasteurized milk concentrate having substantially uniformly distributed milk constituents that do not separate. And for the first time such a milk concentrate can be reconstituted with water within an available juice dispensing system to yield a lowfat reconstituted milk product that has the same characteristics of and tastes like fresh milk. The prior art uses condensed or evaporated milk in the baking industry. But there is no known use for reconstituting a condensed milk for use as a fresh milk beverage available for drinking.

The initial pasteurization process in a specific embodiment of the invention is continuous and treats a skim milk (less than 0.5% fat content) at a flow rate of 3000 gal/hr. The milk is first preheated for 10 minutes ±30 seconds at a temperature of about 150° F. within a temperature range of 144° F. to 152° F. The preheated milk is then pasteurized at about 180°±2° F. for 16-22 seconds and held for 10 minutes ±30 seconds under a vacuum of 23±0.5 inches of mercury with an air temperature of about 145° F. After pasteurization, the HSCS is directed through a plate cooler for 3 minutes at a flow rate of 800 to 1,000 gal/hr where it is cooled to a temperature of less than 40° F.

Heating the milk under vacuum evaporates liquid and thus produces the desired high solids intermediate condensed skim milk, which includes 35.0 to 36.5% milk solids nonfat (MSNF) by weight as required for further processing. The upper and lower limits are critical. A lower MSNF content will not produce an ultrapasteurized milk concentrate required to produce the novel milk beverage of the invention when reconstituted with water. A higher MSNF will produce excessive viscosity of and “burn-on” in the final liquid milk concentrate as it moves through the ultrapasteurizing equipment. In this specific embodiment, the APV-Crepaco Direct Steam Infusion System is the equipment used to effect ultrapasteurization.

After the initial pasteurization, the intermediate HSCS milk concentrate is mixed with cream having a fat content in the range of from about 36% to 42% to form a condensed liquid blend in a batch tank having a capacity of at least 750 gallons. Stabilizer material is then added to the batch of condensed liquid blend to form a final liquid milk concentrate to be subsequently ultrapasteurized. The stabilizers are first mixed under high shear conditions with warm water having a temperature of 95+/−5° F. (90° to 100° F.). The resultant stabilizer slurry includes a stabilizer content in the range of from 14.75 to 21.5% by weight. In the specific embodiment, the stabilizer content includes the stabilizing materials of sodium hexametaphosphate in the range of 14.6 to 20.8% and carrageenan (kappa type) in the range of 0.15% to 0.7%.

The initial stabilizer mixture composition used in forming the slurry of the invention consists essentially of sodium hexametaphosphate in the range of 97.0-99.0% and carrageenan (kappa type) in the range of 1.0-3.0%. The stabilizer slurry is formed by metering the stabilizer mixture and water into a high shear liquifier blender and mixing it for about 15 minutes to get the stabilizer material into solution. If the stabilizer is not solubilized, it will not be evenly distributed in the slurry and as required in the final ultrapasteurized milk concentrate of the invention. The desired amounts of Vitamins A Palmitate (250 ml) and D3 (100 ml) are added to the stabilizer slurry during the blending step. The slurry mixture is then pumped to the batch tank and intermixed with the condensed liquid blend of HSCS milk and cream. The viscosity of the final liquid milk concentrate before ultrapasteurization is 300 to 400 centipoises at 40° to 45° F.

A direct steam infusion system continuously ultrapasteurizes the final liquid milk concentrate at a flow rate of 50 gal/minutes (3,000 gal/hr). The generator section of a plate heat exchanger heats the milk concentrate to a first elevated temperature of about 180° F. for a period of 30 to 36 seconds as it passes through a holding tube. The preheated milk concentrate is then heated to a second elevated temperature of 290° F. for 4 seconds by direct steam infusion to effect ultra-high temperature (UHT) pasteurization and produce the ultrapasteurized liquid milk concentrate that is cooled to 175° F. at a vacuum pan.

The UHT pasteurized liquid milk concentrate is then homogenized at 2500±100 PSI in two stages (1st stage 2000 PSI and 2nd stage 500 PSI) in an industry standard homogenizer and then cooled to less than 40° F. as it flows through the regeneration and cooling sections of the plate heat exchanger of the homogenizer. The homogenized UHT pasteurized blend is pumped to a sterile refrigerated tank and held at a temperature of no greater than 45° F. until packaged. The viscosity of the UHT pasteurized concentrate product is 1000 to 1500 centipoises at 40° to 45° F. The composition of this embodiment of the UHT pasteurized concentrate product of the invention comprises HSCS milk (87-90%); cream (8.5-10.5%); stabilizers (less than 1.0%); and water (2.0-3.0%). These amounts of HSCS milk and cream constituents are required to produce the 1% lowfat milk beverage produced when the ultrapasteurized milk concentrate is reconstituted with potable water at a water concentrate volume ratio of 3 parts water to one part concentrate.

Four milk classifications exist in the industry as designated by the government in terms of the percentage of the milk solids fat content as Full Fat (3.25% Fat); Reduced Fat (2.00% Fat); Low fat (1.00% Fat); and Fat Free (Skim) (<0.21% Fat). The composition of the final liquid milk concentrate of the invention varies depending on the percentage of fat content desired in the reconstituted milk beverage. The percentage of milk solids, nonfat in each final liquid milk concentrate is at least 29.9% to attain at least 8.25% milk solids nonfat content in the reconstituted milk beverage made with the UHT milk concentrate of the invention. The percentage of stabilizer solids in the milk concentrate of the invention in each instance is less than one percent. The following Table I shows the total solids calculated for the UHT pasteurized milk concentrate of the invention based on the concentrate being reconstituted with water in a water to concentrate volume ratio of 3 parts per water to one part milk concentrate.

TABLE I

| | Full Fat | Reduced Fat | Low Fat | Fat Free (Skim) |
|---|---|---|---|---|
| % Fat | 11.77 | 7.24 | 3.62 | <.74 |
| % Milk Solids | =/>29.90 | =/>29.90 | =/>29.90 | =/>29.90 |
| Not Fat | | | | |
| % Stabilizer | <.75 | <.75 | <.75 | <.75 |
| % Total Solids | =/<42.40 | =/<37.89 | =/<33.52 | =/<31.39 |

The following Table II shows the percentage of fat, MSNF, and total solids in reconstituted milk beverages with the characteristics and tastes like any of the four types of fresh milk made by mixing water with the liquid milk concentrate of Table I in a water to concentrate volume ratio of 3:1.

TABLE II

| | Full Fat | Reduced Fat | Low Fat | Fat Free (Skim) |
|---|---|---|---|---|
| % Fat | 3.25 | 2 | 1 | <2.1 |
| % Milk Solids | =/>8.25 | =/>8.25 | =/>8.25 | =/>8.25 |
| Not Fat | | | | |
| % Stabilizer | <.21 | <.21 | <.21 | <.21 |
| % Total Solids | =/>11.71 | =/>10.46 | =/>9.46 | =/<8.67 |

A beverage dispenser manufactured by Wilshire bearing the trademark QUANTUM 4000 operates with a plastic bag package containing the liquid milk concentrate of the invention. A peristaltic pump draws the concentrate from the package and discharges it through a dispensing nozzle to mix it with water flowing at a rate effective to reconstitute the concentrate at a mixing ratio of parts of water to parts of concentrate in a volume ratio range of from about 3:1 to about 4:1. The reconstituted milk beverage has the characteristics of and tastes like fresh milk.

In another specific embodiment, the concentrated milk is loaded into a 300 gallon tri-wall aseptic bag-in-box using an INTASEPT bulk bag-in-box filler. The bag-in-box has a dual layer membrane on the exit port that allows the bag-in-box to connect to a steam sterilized connector that pierces the exit port on the aseptic 300 gallons in the box. This allows the concentrated milk to retain its aseptic atmosphere when penetrated by the sterile connector. The concentrated sterile milk is then unloaded into a sterile blending tank that holds a combination of 2,000 gallons of both sterile water and concentrated milk. The sterile concentrated milk and water are mixed together in the blending tank at the proper mix ratio to reconstitute the milk to regular strength milk. The milk is still in a sterile atmosphere. The regular strength milk is then pumped into a sterile surge holding tank until being pumped to a dairy packaging machine where the product still remains in a sterile atmosphere. It is then packaged in paper milk cartons.

The 300 gallon bag-in-box has a 90 day shelf life from the date of manufacturing. The paper retail package would have the remaining shelf life of the 90 days minus the time from date of manufacturing to the date the 300 gallon bag-in-box is processed for retail packaging. Since the concentrated aseptic milk has remained in a USDA approved aseptic system, the product does not have to be re-pasteurized. As a new and unexpected result, this system allows for a dairy to be established anywhere in the world that local laws permit at a minimum expenditure compared to regular dairies. addition.cip.

It is commonly thought in the dairy industry that ultra-high temperature (UHT) pasteurized milk often contains a “scorched” or “burnt” milk taste as a result of the extremely high temperature to which the milk is heated in the UHT process. Milk is an extremely heat-sensitive product so that when using the indirect heating UHT treatment of regular milk, it has a “scorched” milk flavor and does not taste like fresh milk. Logically, the problem of “scorching” should increase as the solids level in milk increases because there is less water to protect the milk proteins from scorching. Thus, a common belief in the dairy trade is that a milk concentrate having a 3 to 4 times greater concentration level of milk solids than regular milk would have a comparably greater scorched flavor than a single strength UHT milk. So it has been assumed that it would not be possible for a concentrated UHT milk to have a fresh milk taste upon being reconstituted. The disclosed invention has produced surprising results to the contrary.

Condensed or concentrated milk with its high milk solids content has a natural tendency to separate and turn to gel due to the extreme weight of those solids. This problem becomes more pronounced as the product ages. So before this invention, trying to attain a shelf life of 4-6 months seemed unrealistic based on prior experience. Furthermore, many in the industry believed that the product would never be able to maintain any of its stability at such high milk solids levels once it had been subjected to the high temperatures under an UHT treatment. Yet the extended shelf life achieved with the product of this invention has unexpectedly proven both of these previous problems associated with a high milk solids content to be nonexistent.

Finally, the idea of reconstituting concentrated milk with water through a modified juice dispensing machine has never been done before. Once the concentrated milk of the invention was reconstituted with water at the dairies in which the product of this invention was developed, plant managers and workers could not believe its “fresh” milk taste and its stable product consistency and texture. Their surprise was compounded by the fact that the product could be dispensed through a machine.

Another embodiment of a process to produce an aseptic, shelf stable UHT milk concentrate of the invention starts with a liquid milk concentrate having a nonfat milk solids content in the range of from about 29.5% to about 42% by weight with an optimum content range of about 39% to 40% by weight to ultimately produce a reconstituted milk beverage by mixing 3.5 parts water to one part of the UHT milk concentrate. The industry-wide fat content classification of the different types of milk is from less than 0.21% up to 3.25% by weight of butterfat thus including fat free (<0.21% fat content) milk, low fat (1% fat content) skim, reduced fat (2% fat content) milk and full fat (3.25% fat content) milk. So depending on the particular classification desired in the reconstituted milk beverage of the invention, a sufficient amount of cream may be mixed with the starting liquid milk concentrate to provide a condensed liquid milk blend having a sufficient amount of fat content effective to form a reconstituted milk beverage having a fat content of from less than 0.21% up to 3.25% by weight of the reconstituted milk beverage when the ultrapasteurized liquid milk concentrate is reconstituted with water. If no fat is desired to make a no fat product, no cream or fat is needed in the mixture.

A stabilizer is then first prepared for adding to the liquid milk concentrate to form the condensed liquid milk blend that is to be ultrapasteurized. In this embodiment, one (1) pound of stabilizer consisting of sodium hexametaphosphate and carrageenan (kappa type) is mixed with two (2) pounds of warm water (70° F. minimum). The resultant mixture is then blended together in a high shear blender for 10 minutes to form a stabilizer slurry, which is then mixed with the initial liquid milk concentrate for at least 20 minutes to produce the condensed liquid milk blend that is to be UHT pasteurized. The stabilizer is about 0.7% of the total weight of the condensed liquid milk blend that includes cream.

The resultant condensed liquid milk blend is then continuously run through a Tetra Pak VTIS direct steam injection UHT pasteurization system that uses a prewarming step and then heats the milk to a temperature range of from 288° F. to 294° F. for 2.5 to 5 seconds. In this embodiment, the ultrapasteurizing temperature is 294° F. The UHT milk concentrate is then sent to a cooling condenser, which cools the concentrate to a temperature of from about 80° F. to 90° F. within 2 to 5 seconds. The UHT milk concentrate is then run through a high-pressure homogenizer at 3500 to 5000 psi and sent to an aseptic bag filler machine that sterilizes the bag with steam before it is filled with the sterilized UHT milk concentrate. The final product is checked for proper milk solids and fat content as well as the proper pH level. The milk concentrate includes a total milk solids content of from about 40% to about 46% by weight when it is running through the direct steam injection system, homogenizer, and cooling condenser.

While the ULTRA-HIGH TEMPERATURE MILK CONCENTRATE PACKAGE AND METHOD OF PRODUCING SAME has been shown and described in detail, it is obvious that this invention is not to be considered as limited to the exact form disclosed, and that changes in detail and construction may be made therein within the scope of the invention without departing from the spirit thereof.

Having thus set forth and disclosed the nature of this invention, what is claimed is:

1. A method for producing an ultrapasteurized liquid milk concentrate for mixing with water to provide a reconstituted milk beverage that tastes like fresh milk, said method comprising:
a) providing a condensed liquid milk blend including a stabilizer, a pasteurized liquid milk concentrate, and an amount of nonfat milk solids sufficient to produce an ultrapasteurized liquid milk concentrate having a nonfat milk solids content of at least 29.9% by weight when said ultrapasteurized liquid milk concentrate is reconstituted with water,
b) said stabilizer being present in a sufficient amount effective to produce a protein complex that forms a stable dispersion of substantially uniformly distributed colloidal constituents in said condensed liquid milk blend,
c) said stabilizer being further effective to inhibit thermal coagulation of milk proteins at a preselected pH of said condensed liquid milk blend, and then
d) directing a continuous flow of said condensed liquid milk blend into direct contact with steam at an effective ultrapasteurizing temperature for a time sufficient to form said ultrapasteurized liquid milk concentrate having a nonfat milk solids content of at least 29.9% by weight.

2. A method as defined in claim 1 wherein
said continuous flow directing step includes heating said condensed liquid milk blend in direct contact with said steam to a temperature in the range of 288° F. to 294° F. for a period of time sufficient to produce said ultrapasteurized liquid milk concentrate.

3. A method as defined in claim 2 wherein
said continuous flow directing step includes first heating said condensed liquid milk blend to a first temperature of about 180° F. for a period of from 30 to 36 seconds, and then
directing the heated condensed liquid milk blend into direct contact with said steam at a temperature of 290° F. for a period of four seconds to form said ultrapasteurized liquid milk concentrate.

4. A method as defined in claim 1 wherein
the viscosity of the condensed liquid milk blend is in the range of 300 to 400 centipoises at 40° to 45° F., and
the viscosity of the ultrapasteurized liquid milk concentrate is in the range of 1000 to 1500 centipoises at 40° to 45° F.

5. A method as defined in claim 1 wherein
said stabilizer is effective to maintain said preselected pH of said condensed liquid milk blend in the range of 6 to 8 during said continuous flow directing step.

6. A method as defined in claim 1 wherein
said stabilizer in said condensed liquid milk blend includes sodium hexametaphosphate and carrageenan,
said carrageenan being effective to form a protein carrageenate complex with milk protein to provide said stable dispersion of colloidal constituents, and
said sodium hexametaphosphate being effective to aid in substantially uniformly distributing said colloidal constituents and inhibiting said thermal coagulation.

7. A method as defined in claim 1 wherein
said condensed liquid milk blend providing step includes first solubilizing said stabilizer in water under high shear conditions and at an elevated temperature to form a stabilizer slurry that is mixed with said pasteurized liquid milk concentrate to form said condensed liquid milk blend.

8. A method as defined in claim 7 wherein
said stabilizer slurry includes a sufficient amount of stabilizer to produce said condensed liquid milk blend having a stabilizer content of less than 1.0% by weight.

9. A method as defined in claim 8 wherein
said sufficient amount of stabilizer in said stabilizer slurry is in the range of 14.75% to 21.5% by weight of said stabilizer slurry.

10. A method as defined in claim 7 wherein
said stabilizer in said stabilizer slurry consists essentially of sodium hexametaphosphate in the range of 14.6% to 20.8% and carrageenan (kappa type) in the range of 0. 15% to 0.7% each by weight of said stabilizer slurry.

11. A method as defined in claim 1 further including the steps of
homogenizing said ultrapasteurized liquid milk concentrate, and then
packaging said homogenized ultrapasteurized liquid milk concentrate for subsequent mixing of the ultrapasteurized milk concentrate with water to form said reconstituted milk beverage.

12. A method as defined in claim 11 wherein
said homogenizing step comprises homogenizing said ultrapasteurized milk concentrate in the range of 2,400 to 2,600 PSI in a first stage of about 2,000 PSI and a second stage of about 500 PSI.

13. A method as defined in claim 11 wherein
said packaging step includes the step of cooling said ultrapasteurized milk concentrate and disposing said ultrapasteurized milk concentrate in a liquid beverage dispenser with package filling means.

14. A method as defined in claim 13 wherein
said packaging step includes disposing said ultrapasteurized milk concentrate in a package for use in a beverage dispenser that includes discharge nozzle means for mixing said ultrapasteurized milk concentate with water to form said reconstituted milk beverage.

15. A method as defined in claim 13 wherein
said packaging step includes the step of cooling said ultrapasteurized milk concentrate to a temperature of about 80° F. to about 90° F. and disposing said milk concentrate in an asceptic package container.

16. A method as defined in claim 15 wherein
said packaging step includes disposing up to 300 gallons of said ultrapasteurized milk concentrate in said asceptic package container.

17. A method as defined in claim 13 wherein
said packaging step includes disposing said ultrapasteurized milk concentrate in a package container for subsequent reconstitution with water at a water to milk concentrate mixing volume ratio in the range of 3:1 to 4:1.

18. A method as defined in claim 1 wherein
said condensed liquid milk blend includes a sufficient amount of cream to provide a sufficient amount of fat content effective to form a reconstituted milk beverage having a fat content of from less than 0.21% up to 3.25% by weight of said milk beverage when said ultrapasteurized liquid milk concentrate is reconstituted with water.

19. An ultrapasteurized milk concentrate as produced by any one of the methods of claims 1, 11, 13, 14, 15, 16, 17, or 18.

20. A method for producing an ultrapasteurized liquid milk concentrate to be mixed with water to form a reconstituted milk beverage, said method comprising the steps of:
a) providing a pasteurized liquid milk concentrate having an amount of nonfat milk solids sufficient to produce said ultrapasteurized liquid milk concentrate having a nonfat milk solids content of at least 29.9% by weight when said ultrapasteurized liquid milk concentrate is reconstituted with water,
b) mixing a sufficient amount of cream with said pasteurized liquid milk concentrate to provide a condensed liquid blend having a sufficient amount of fat content effective to form a reconstituted milk beverage having a fat content of from less than 0.21% up to 3.25% by weight of said milk beverage when said ultrapasteurized liquid milk concentrate is reconstituted with water, and
c) mixing a sufficient amount of stabilizer with said condensed liquid blend effective to produce a protein complex that forms a stable dispersion of substantially uniformly distributed colloidal constituents in said condensed liquid blend,
d) said stabilizer being further effective to inhibit thermal coagulation of milk proteins at a preselected pH of said condensed liquid blend.

21. A method as defined in claim 20 wherein
said stabilizer in said condensed liquid blend includes sodium hexametaphosphate and carrageenan,
said carrageenan being effective to form a protein carrageenate complex with milk protein to provide said stable dispersion of colloidal constituents, and
said sodium hexametaphosphate being effective to aid in substantially uniformly distributing said colloidal constituents and inhibiting said thermal coagulation.

22. A method as defined in claim 20 wherein
said stabilizer mixing step includes first solubilizing said stabilizer in water under high shear conditions and at an elevated temperature to form a stabilizer slurry that is mixed with said pasteurized liquid milk concentrate and cream to form said condensed liquid milk blend.

23. A method as defined in claim 22 wherein
said stabilizer slurry includes a sufficient amount of stabilizer to produce said condensed liquid milk blend having a stabilizer content of less than 1.0% by weight.

24. A method as defined in claim 20 wherein
said pasteurized liquid milk concentrate includes a nonfat milk solids content in an amount of at least 35% by weight.

25. A method as defined in claim 20 wherein
said cream includes a milk fat content in the range of about 36.0% to about 42.0% by weight.

26. A method as defined in claim 25 wherein
said sufficient amount of cream in said cream mixing step is effective to produce a cream content in the range of about 8.5% to about 10.5% by weight of said condensed liquid milk blend.

27. A method as defined in claim 20 wherein
said condensed liquid milk blend includes said liquid milk concentrate in the range of from about 87% to about 90% by weight, cream in the range of from about 8.5% to about 10.5% by weight, water in the range of from about 2.0% to about 3.0% by weight, and stabilizer in the amount of less than 1.0% by weight.

28. A method as defined in claim 27 wherein
said reconstituted milk beverage includes a milk fat content in the range of from less than 0.21% to 3.25% by weight and a nonfat milk solids content of at least 8.25% by weight.

29. An asceptic ultrapasteurized milk concentrate package of ultrapasteurized liquid milk concentrate, said package comprising:
a) container means including a preselected amount of said ultrapasteurized liquid milk concentrate, b) said ultrapasteurized liquid milk concentrate including a stabilizer and an amount of nonfat milk solids sufficient to produce an ultrapasteurized liquid milk concentrate having a nonfat milk solids content of at least 29.5% by weight when said ultrapasteurized liquid milk concentrate is reconstituted with water,
c) said stabilizer being present in a sufficient amount effective to produce a protein complex that forms a stable dispersion of substantially uniformly distributed colloidal constituents in said condensed liquid milk blend,
d) said stabilizer being further effective to inhibit thermal coagulation of milk proteins at a preselected pH of said condensed liquid milk blend.

30. A package as defined in claim 29 wherein
said ultrapasteurized liquid milk concentrate includes a high-solids condensed skim milk in the range of 87% to 90% by weight, a cream content in the range of from 8.5% to 10.5% by weight, and a stabilizer content of less than 1% by weight.

31. A package as defined in claim 29 wherein
said stabilizer content in said ultrapasteurized liquid milk concentrate is less than 1% by weight and includes sodium hexametaphosphate in the range of 97.0% to 99.0% by weight of said stabilizer and carrageenan (kappa type) content in the range of 1.0% to 3.0% by weight of said stabilizer.

32. A package as defined in claim 29 wherein
said milk concentrate package has a structural configuration effective for disposition in a liquid dispensing means including discharge nozzle means for mixing said ultrapasteurized milk concentrate with water to dispense said reconstituted liquid milk beverage.

33. A package as defined in claim 29 wherein
said preselected amount of said ultrapasteurized liquid milk concentrate includes up to 300 gallons and is disposed in a bag for storage and shipping.

34. A package as defined in claim 29 wherein
said container has a structural configuration effective for use with dispensing means which includes means for mixing said ultrapasteurized milk concentrate with water to form a reconstituted liquid milk beverage that tastes like fresh milk,
